(19) United States
(12) Patent Application Publication
(10) Pub. No.: US 2026/0081209 A1
(43) Pub. Date: Mar. 19, 2026

(54) SEMI-SOLID BATTERY

(71) Applicant: ISUZU MOTORS LIMITED, Yokohama-shi (JP)

(72) Inventor: Hiroyuki MATSUMOTO, Fujisawa-shi (JP)

(21) Appl. No.: 19/277,686

(22) Filed: Jul. 23, 2025

(30) Foreign Application Priority Data
Sep. 13, 2024 (JP) 2024-158894

(51) Int. Cl. H01M 10/056

(52) U.S. Cl. CPC H01M 10/056; H01M 2300/0071; H01M 2300/0091

(57) ABSTRACT

A semi-solid battery includes a positive electrode layer that includes a positive electrode current collector and positive electrode active materials, a negative electrode layer that includes a negative electrode current collector and negative electrode active materials, and an electrolyte layer that is provided between the positive electrode layer and the negative electrode layer and has an electrolyte solution with fluidity between adjacent solid electrolyte particles, wherein the electrolyte layer includes oxide particles that are in contact with the solid electrolyte particle and adsorb the electrolyte solution.

### CROSS-REFERENCE TO RELATED APPLICATIONS

The present application claims priority to Japanese Patent Application number 2024-158894, filed on Sep. 13, 2024, contents of which are incorporated herein by reference in its entirety.

### BACKGROUND OF THE INVENTION

The present disclosure relates to a semi-solid battery.

A conventional all-solid-state secondary battery includes a positive electrode including a positive electrode current collector and a positive electrode active material layer, a negative electrode including a negative electrode current collector and a negative electrode active material layer, and a solid electrolyte layer disposed between the positive electrode and the negative electrode (for example, Japanese Unexamined Patent Application Publication No. 2021-141064).

### Problem to be Solved by the Invention

In a solid electrolyte layer, ions migrate through a contact region between a solid electrolyte and another solid electrolyte, and if the contact region of each solid electrolyte is small, an increase in resistance to ion migration occurs. Therefore, a method may be considered in which an electrolyte solution is included in the solid electrolyte layer to allow ions to migrate through regions other than the contact regions, but in this method, as an amount of the electrolyte solution increases, problems are likely to occur, such as an increase in viscosity at low temperatures, which leads to higher resistance, and decomposition of the electrolyte solution at high temperatures. On the other hand, if the amount of the electrolyte solution is small, solid electrolytes not wetted by the electrolyte solution may cause an increase in resistance to ion migration, and the electrolyte solution may solidify.

### BRIEF SUMMARY OF THE INVENTION

The present disclosure focuses on this point, and an object thereof is to promote ion migration in an electrolyte layer with a small amount of electrolyte solution.

A semi-solid battery according to the present disclosure includes a positive electrode layer that includes a positive electrode current collector and positive electrode active materials, a negative electrode layer that includes a negative electrode current collector and negative electrode active materials, and an electrolyte layer that is provided between the positive electrode layer and the negative electrode layer and has an electrolyte solution with fluidity between adjacent solid electrolyte particles, wherein the electrolyte layer includes oxide particles that are in contact with the solid electrolyte particle and adsorb the electrolyte solution.

### BRIEF DESCRIPTION OF THE DRAWINGS

FIG. 1 shows an overview of a semi-solid battery 1 according to the present embodiment.

FIG. 2 shows paths of ions migrating through an electrolyte solution 32.

FIG. 3 is a graph showing a resistance value of a cell with respect to an amount of electrolyte solution.

FIG. 4 shows input and output of the semi-solid battery 1 with respect to temperature.

FIG. 5 shows a solid electrolyte particle 31 coated with oxide particles 33.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Overview of Half Solid-State Battery 1

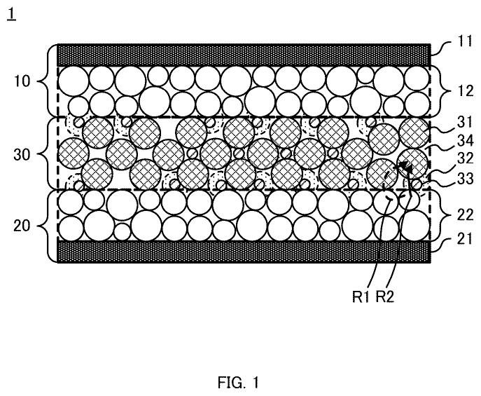

FIG. 1 shows an overview of a semi-solid battery 1 according to the present embodiment. The semi-solid battery 1 shown in FIG. 1 includes a positive electrode layer 10, a negative electrode layer 20, and an electrolyte layer 30, and has a structure in which the negative electrode layer 20, the electrolyte layer 30, and the positive electrode layer 10 are stacked in this order. The semi-solid battery 1 is a secondary battery, and is a lithium-ion battery, for example.

The positive electrode layer 10 is a layer that serves as a positive electrode through which ions (e.g., lithium ions in the case of a lithium-ion battery) migrate when the semi-solid battery 1 discharges, and includes a positive electrode current collector 11 and positive electrode active materials 12. The positive electrode current collector 11 is a conductor for collecting current, and is made of aluminum, for example. The positive electrode active material 12 is a material that receives the ions during discharge, and is lithium cobalt oxide, for example.

The negative electrode layer 20 is a layer that serves as a negative electrode through which the ions migrate when the semi-solid battery 1 charges, and includes a negative electrode current collector 21 and negative electrode active materials 22. The negative electrode current collector 21 is a conductor for collecting current, and is made of copper, for example. The negative electrode active material 22 is a material that receives the ions during charging, and is graphite, for example.

The electrolyte layer 30 is provided between the positive electrode layer 10 and the negative electrode layer 20, and includes a plurality of solid electrolyte particles 31. The solid electrolyte particle 31 is a substance for allowing migration of the ions to the positive electrode active materials 12 when the semi-solid battery 1 discharges, and allowing migration of the ions to the negative electrode active materials 22 when the semi-solid battery 1 charges. For example, the solid electrolyte particle 31 is an oxide-based solid electrolyte such as a perovskite-type La_{0.51}Li_{0.34}TiO_{2.94}, but may be a sulfide-based solid electrolyte, halide-based solid electrolyte, or hydride-based solid electrolyte.

In the electrolyte layer 30, the electrolyte solution 32 with fluidity is present between adjacent solid electrolyte particles 31. The electrolyte solution 32 is, for example, a mixed solvent of cyclic carbonate and chain carbonate, specifically, a mixed solvent of ethylene carbonate and dimethyl carbonate.

Since the electrolyte solution 32 is present as described above, the ions can migrate along the shorter of the following paths: a) a path through a contact surface between a solid electrolyte particle 31 and another solid electrolyte particle 31, and b) a path through an electrolyte solution 32 in contact with a solid electrolyte particle 31 and another solid electrolyte particle. Specifically, when the electrolyte solution 32 is not present, the ions migrate along a path R1 shown in FIG. 1, but when the electrolyte solution 32 is present, the ions migrate along a path R2 which is shorter than the path R1. As a result, in the semi-solid battery 1, the time required for ion migration can be shortened compared to the case where the electrolyte solution 32 is not present, thereby facilitating an increase in output.

However, when the temperature of the electrolyte solution 32 becomes low (e.g., 5° C. or lower), its viscosity increases, which increases the internal resistance and lowers the voltage, thereby decreasing the charge/discharge capacity. On the other hand, if the temperature rises to a high level (e.g., 40° C. or higher), the electrolyte solution 32 may react with the positive electrode active materials 12 or the negative electrode active materials 22, or undergo self-decomposition, also leading to a decrease in charge/discharge capacity. If an amount of the electrolyte solution 32 in the electrolyte layer 30 is reduced to suppress a decrease in charge/discharge capacity due to such temperature changes, problems may arise in which the ions have difficulty migrating at solid electrolyte particles 31 not wetted by the electrolyte solution 32, and the electrolyte solution 32 may also solidify.

In contrast, the electrolyte layer 30 includes oxide particles 33 that are in contact with the solid electrolyte particle 31 and adsorb the electrolyte solution 32. The oxide particle 33 is an oxide of a metal element having a larger size than metal elements such as nickel or aluminum, and is zirconium oxide or tungsten dioxide, for example. With such a configuration, in the electrolyte layer 30, the oxide particles 33 with the electrolyte solution 32 adsorbed thereon can be dispersed in contact with the solid electrolyte particles 31, so that each solid electrolyte particle 31 can be in contact with the electrolyte solution 32 even when the amount of the electrolyte solution 32 is small. As a result, in the electrolyte layer 30, the ions can easily migrate through the electrolyte solution 32 even when the amount of the electrolyte solution 32 is small.

Furthermore, in the vicinity of the oxide particles 33, the melting point of the electrolyte solution 32 may be lowered and the ionic conductivity may be increased due to the presence of the oxide particles 33. As a result, in the electrolyte layer 30, a decrease in charge/discharge capacity can be suppressed. In addition, by using an oxide of a metal element having a relatively large size among metal elements, such as zirconia or tungsten oxide, as the oxide particles 33 in the electrolyte layer 30, the surface area of the oxide particles 33 can be increased. As a result, the oxide particles 33 i) can more effectively suppress a decrease in charge/discharge capacity, and ii) can also suppress a change in the crystal structure of the solid electrolyte particles 31 caused by the diffusion of metal elements due to a reaction between the oxide particles 33 and the solid electrolyte particles 31, which would make the ion migration more difficult.

A configuration of the electrolyte layer 30 will be described in detail below.

### Configuration of Electrolyte Layer 30

As shown in FIG. 1, the electrolyte layer 30 includes a plurality of solid electrolyte particles 31, a plurality of oxide particles 33, a void portion 34 surrounded by the plurality of solid electrolyte particles 31, and an electrolyte solution 32 which is in a partial region of the void portion 34. As an example, when the void portion 34 occupies 20% of the volume of the electrolyte layer 30, the volume of a partial region is 25% of the void portion 34 (i.e., 5% of the volume of the electrolyte layer 30).

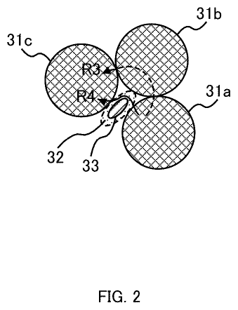

Since the oxide particles 33 containing zirconia oxide or tungsten dioxide do not allow ions to pass through the inside of the oxide particles 33, ions migrate through the electrolyte solution 32 adsorbed on the oxide particles 33. FIG. 2 shows paths of the ions migrating through the electrolyte solution 32. FIG. 2 shows a plurality of solid electrolyte particles 31 (solid electrolyte particles 31a, 31b, and 31c), an electrolyte solution 32, and an oxide particle 33. In FIG. 2, the ions migrate from the solid electrolyte particle 31a to the solid electrolyte particle 31c. When the electrolyte solution 32 and the oxide particles 33 are absent, the ions migrate along a path R3. However, when the electrolyte solution 32 and the oxide particles 33 are present, the ions migrate along a path R4, which is shorter than the path R3 and passes through the electrolyte solution 32.

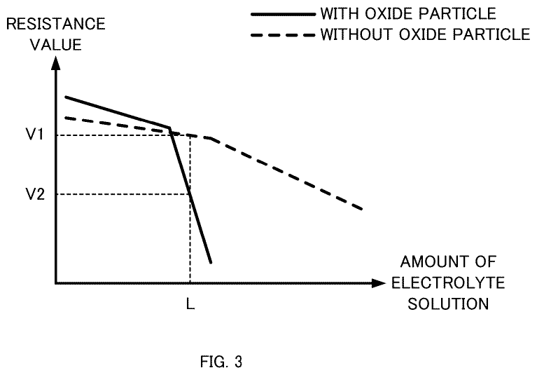

With the above-described configuration, in the electrolyte layer 30, the ions can migrate through the electrolyte solution 32 adsorbed on the oxide particles 33 that are in contact with the solid electrolyte particles 31 (or in proximity to the solid electrolyte particles 31), and the ion migration distance can be shortened. As a result, the semi-solid battery 1 can facilitate the ion migration (i.e., reduce a resistance value of a cell) even with a small amount of the electrolyte solution 32. FIG. 3 is a graph showing the resistance value of the cell with respect to the amount of electrolyte solution. The horizontal axis in FIG. 3 represents the amount of electrolyte solution, and the vertical axis in FIG. 3 represents the resistance value of the cell. As shown in FIG. 3, when the amount of the electrolyte solution is L, the resistance value of the cell of the semi-solid battery 1 that does not include the oxide particles 33 is V1, whereas the resistance value of the cell of the semi-solid battery 1 that includes the oxide particles 33 is V2, which is lower than V1.

Further, in the vicinity of the oxide particles 33, the melting point of the electrolyte solution 32 is lowered and the ionic conductivity is increased, so that the semi-solid battery 1 can suppress a decrease in charge/discharge capacity even at a low temperature.

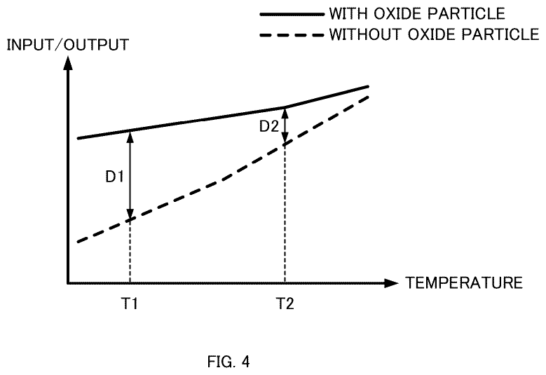

FIG. 4 shows input and output of the semi-solid battery 1 with respect to temperature. The horizontal axis of FIG. 4 represents the temperature in the semi-solid battery 1, and the vertical axis of FIG. 4 represents input and output of the semi-solid battery 1. For example, the input refers to an amount of charge per unit time, and the output refers to an amount of discharge per unit time. As shown in FIG. 4, the input and output of the semi-solid battery 1 that includes the oxide particles 33 do not decrease at low temperatures (solid line), unlike the input and output of the semi-solid battery 1 that does not include the oxide particles 33 (broken line). Specifically, the difference between the solid line and the broken line is D2 at a temperature T2, but the difference between the solid line and the broken line is D1, which is greater than D2, at a temperature T1, which is lower than the temperature T2.

In the electrolyte layer 30, the more uniformly the oxide particles 33 having the electrolyte solution 32 adsorbed thereon are dispersed, the smaller the amount of the electrolyte solution 32 can be. In the electrolyte layer 30, the oxide particles 33 are easily uniformly dispersed by using a metal element having a relatively large size among metal elements as the oxide particles 33. However, even when the oxide particles 33 are included in the electrolyte layer 30, the oxide particles 33 are not necessarily uniformly dispersed. Furthermore, since the oxide particles 33 are inactive, an increase in the amount of the oxide particles 33 increases the proportion of inactive material in the electrolyte layer 30, resulting in a decrease in energy density.

Therefore, the electrolyte layer 30 may include the oxide particles 33 that are coated on the surface of the solid electrolyte particles 31 and have a particle size smaller than that of the solid electrolyte particles 31. The surface of the solid electrolyte particle 31 coated with the oxide particles 33 may include a region coated with the oxide particles 33 and a region not coated with the oxide particles 33. That is, the semi-solid battery 1 may be assembled by incorporating, into the electrolyte layer 30, the plurality of solid electrolyte particles 31 having the oxide particles 33 pre-coated on a partial region of their surfaces.

With the above-described configuration, the probability of uniform dispersion of the oxide particles 33 in the electrolyte layer 30 can be increased. As a result, the electrolyte layer 30 can include an appropriate amount of the oxide particles 33 to achieve uniform dispersion, thereby suppressing a decrease in energy density. Furthermore, by uniformly dispersing the oxide particles 33, the electrolyte solution 32 can also be uniformly dispersed, so that the electrolyte solution 32 is more likely to be present in proximity to each of the solid electrolyte particles 31, thereby enabling a reduction in the amount of the electrolyte solution 32. As a result, in the electrolyte layer 30, the ions can easily migrate even with a small amount of the electrolyte solution 32.

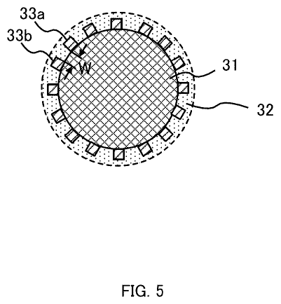

FIG. 5 shows a solid electrolyte particle 31 coated with oxide particles 33. FIG. 5 shows a solid electrolyte particle 31, an electrolyte solution 32, and a plurality of oxide particles 33. For convenience of explanation, FIG. 5 shows the plurality of oxide particles 33 coated on an outer periphery of a cross-sectional surface of the solid electrolyte particle 31 obtained by cutting it along a single plane, and among them, an oxide particle 33a and an oxide particle 33b are designated by reference numerals.

As shown in FIG. 5, the electrolyte layer 30 includes a predetermined number or less of oxide particles 33 coated on the surface of the solid electrolyte particle 31 at a predetermined interval W, for example. The predetermined number is, for example, 16, either on the outer periphery of a cross-sectional surface of the solid electrolyte particle 31 obtained by cutting it along a single plane, or on the entire surface of the solid electrolyte particle 31. The predetermined interval W is a value obtained by dividing the length of the outer periphery of the solid electrolyte particle 31 by the number of oxide particles 33 disposed on the one outer periphery of the solid electrolyte particle 31. With such a configuration, regions of the solid electrolyte particle 31 where the ions cannot migrate (i.e., regions coated with the oxide particles 33) can be dispersed, thereby facilitating the ion migration.

The volume of the oxide particles 33 coated on the solid electrolyte particle 31 may be less than a predetermined ratio of the volume of the solid electrolyte particle 31. The predetermined ratio is a fixed value of 1% or more and 2% or less, for example. Specifically, when the radius of a solid electrolyte particle 31 is 10 μm and the radius of an oxide particle 33 is 1 μm, the volume of an oxide particle 33 is 0.1% of the volume of the solid electrolyte particle 31. Accordingly, when the predetermined ratio is 2%, fewer than 20 oxide particles 33 are coated on each solid electrolyte particle 31. With such a configuration, an unnecessary increase in the volume of the oxide particle 33 can be suppressed, and as a result, the semi-solid battery 1 can suppress a decrease in energy density.

### First Modification

In the above description, a configuration in which the solid electrolyte particles 31 included in the electrolyte layer 30 are coated with the oxide particles 33 is exemplified, but the present disclosure is not limited thereto. In the semi-solid battery 1, the positive electrode layer 10 may include the oxide particles 33 coated on the surface of the positive electrode active materials 12, and the negative electrode layer 20 may include the oxide particles 33 coated on the surface of the negative electrode active materials 22. In the positive electrode layer 10, the electrolyte solution 32 may be present between the adjacent positive electrode active materials 12, and in the negative electrode layer 20, the electrolyte solution 32 may be present between the adjacent negative electrode active materials 22.

With such a configuration, the ions can migrate through the electrolyte solution 32 adsorbed on the oxide particles 33 in the positive electrode layer 10 and the negative electrode layer 20. As a result, in the semi-solid battery 1, the ion migration can be more effectively promoted than in the case where the oxide particles 33 are coated only on the solid electrolyte particles 31, and the output can thereby be increased.

### Second Modification

In the above description, a configuration in which the solid electrolyte particles 31 are included in the electrolyte layer 30 is exemplified, but the present disclosure is not limited thereto. The solid electrolyte particle 31 may be further included in at least one of the positive electrode layer 10 or the negative electrode layer 20. The surface of the solid electrolyte particle 31 may be coated with the oxide particles 33.

### Effect of Semi-Solid Battery 1

As described above, the semi-solid battery 1 includes the positive electrode layer 10 including the positive electrode current collector 11 and the positive electrode active materials 12, the negative electrode layer 20 including the negative electrode current collector 21 and the negative electrode active materials 22, and the electrolyte layer 30 provided between the positive electrode layer 10 and the negative electrode layer 20 and having the electrolyte solution 32 with fluidity between the adjacent solid electrolyte particles 31, and the electrolyte layer 30 includes the oxide particles 33 that are in contact with the solid electrolyte particle 31 and adsorb the electrolyte solution 32.

With the semi-solid battery 1 configured as described above, in the electrolyte layer 30, the oxide particles 33 on which the electrolyte solution 32 is adsorbed are dispersed in a state of being in contact with each of the solid electrolyte particles 31, and thus it is possible to easily allow the ions to migrate even when the amount of the electrolyte solution 32 is small. Further, as shown in FIG. 5, by coating the surface of the solid electrolyte particle 31 with the oxide particles 33 at predetermined intervals, the oxide particles 33 can be uniformly dispersed. As a result, in the semi-solid battery 1, the electrolyte solution 32 wetting the oxide particles 33 can be uniformly dispersed, and so the amount of the electrolyte solution 32 can be easily reduced.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A semi-solid battery comprising:
a positive electrode layer that includes a positive electrode current collector and positive electrode active materials;
a negative electrode layer that includes a negative electrode current collector and negative electrode active materials; and
an electrolyte layer that is provided between the positive electrode layer and the negative electrode layer and has an electrolyte solution with fluidity between adjacent solid electrolyte particles, wherein
the electrolyte layer includes oxide particles that are in contact with the solid electrolyte particle and adsorb the electrolyte solution.

2. The semi-solid battery according to claim 1, wherein
the electrolyte layer includes a plurality of the solid electrolyte particles, a plurality of the oxide particles, a void portion surrounded by the plurality of the solid electrolyte particles, and the electrolyte solution which is in a partial region of the void portion.

3. The semi-solid battery according to claim 1, wherein
the electrolyte layer includes the oxide particles coated on a surface of the solid electrolyte particle and having a particle size smaller than that of the solid electrolyte particle.

4. The semi-solid battery according to claim 3, wherein
the electrolyte layer includes a predetermined number or less of the oxide particles coated on the surface of the solid electrolyte particle at predetermined intervals.

5. The semi-solid battery according to claim 3, wherein
the surface of the solid electrolyte particle includes a region coated with the oxide particles and a region not coated with the oxide particles.

6. The semi-solid battery according to claim 1, wherein
the oxide particles contain zirconia oxide or tungsten dioxide.

7. The semi-solid battery according to claim 1, wherein
the positive electrode layer includes the oxide particles coated on a surface of the positive electrode active material, and the negative electrode layer includes the oxide particles coated on a surface of the negative electrode active material.

8. The semi-solid battery according to claim 3, wherein
a volume of the oxide particles coated on the solid electrolyte particle is less than a predetermined ratio of a volume of the solid electrolyte particle.

9. The semi-solid battery according to claim 3, wherein
the solid electrolyte particle coated with the oxide particles is further included in at least one of the positive electrode layer or the negative electrode layer.
